(19) United States
(12) Patent Application Publication
(10) Pub. No.: US 2024/0028550 A1
(43) Pub. Date: Jan. 25, 2024

(54) LAN PCIE BANDWIDTH OPTIMIZATION

(71) Applicant: Intel Corporation, Santa Clara, CA (US)

(72) Inventor: Dekel SHIRIZLY, Binyamina (IL)

(21) Appl. No.: 18/375,393

(22) Filed: Sep. 29, 2023

(51) Int. Cl. G06F 13/42; G06F 13/28

(52) U.S. Cl. CPC G06F 13/4282; G06F 13/28

(57) ABSTRACT

Methods and apparatus for LAN PCIe bandwidth optimization. Packets to be sent outbound onto a network are generated and buffered in memory on a host computing device. Transmit (Tx) descriptors associated with respective packets are generated comprising descriptor data and at least a portion of the packet data for the packet, where the descriptor data are configured to be processed by a network apparatus coupled to the network, such as a network interface controller (NIC) or network adapter. Tx descriptors are transferred from host memory to the network apparatus over a Peripheral Component Internet Express (PCIe) interconnect using a single respective transaction level packet (TLP) per Tx descriptor. This increases bandwidth utilization for the PCIe interconnect by reducing the number of TLPs that are used to transfer Tx descriptors and packet data to the network apparatus. The novel Tx descriptors may be used for LAN and Wireless LANs.

### BACKGROUND INFORMATION

Peripheral Component Interconnect Express (PCIe) is an Input/Output (I/O) interface that is ubiquitous in computing devices such as servers, desktop computers, laptops, notebooks, Chromebooks, etc. Likewise, the use of network interface controllers (NICs, also referred to as network interfaces, network cards, network adapters, etc.) in such computing devices is also ubiquitous. NICs may be used to connect to Local Area Networks (LANs) that employ one of more versions of Ethernet protocols. Ethernet uses Ethernet frames and Ethernet packets having variable sizes. NICs are used to receive Ethernet frames and perform related operations, including extracting Ethernet packets from the Ethernet frames.

PCIe also implements packet-based communications, such as through use of transaction layer packets (TLPs). Transactions over PCIe interfaces are based on fixed-size TLP packet, where each transaction will use at least one TLP packet regardless of how small the transaction data are. When the Ethernet packet size is slightly larger than the TLP packet size, the bandwidth of the PCIe interface is dramatically reduced. For example, consider a worst case scenario where the Ethernet packet size is 65 Bytes and the TLP size is 64 Bytes. This will require two TLP packets and associated transactions consuming 128 Bytes over the PCIe interface, reducing utilization of the interface by almost 50%.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram illustrating use of transmit (Tx) descriptors using a current approach;

FIG. 2 is a flowchart illustrating operation and logic employed to generate Tx descriptors with packet data, according to one embodiment;

FIG. 3 is a diagram illustrating the format of Tx descriptors and TLP data chunks for four exemplary packets;

FIG. 4a is a diagram showing four Tx descriptors stored on a Tx descriptor ring;

FIG. 4b is a diagram showing n Tx descriptors stored as a circular linked list;

FIG. 5 is a flowchart illustrating operations and logic for transferring packet data from host memory to a Tx buffer on a NIC using Tx descriptors with packet data, according to one embodiment;

FIG. 6a is a schematic diagram depicting transfer and handling of a first Tx descriptor containing all the packet data for a first packet using an exemplary platform architecture; according to one embodiment;

FIG. 6b is a schematic diagram depicting transfer and handling of a second Tx descriptor containing a portion of the packet data for a second packet that further includes additional data using the exemplary platform architecture of FIG. 6a, according to one embodiment;

FIG. 7a is a diagram of a Tx descriptor structure with packet data, according to one embodiment;

FIG. 7b is a diagram of a Tx descriptor structure with packet data, according to one embodiment;

FIG. 8 is a schematic diagram illustrating a system architecture that may be used to implement aspects of workflows for received packets, according to one embodiment;

FIG. 9 is a schematic diagram illustrating an architecture for a NIC that may be used for implementing aspects of the network hardware devices disclosed herein, according to one embodiment;

FIG. 10 is a diagram of an exemplary IPU card, according to one embodiment; and

FIG. 11 is a diagram of an exemplary SmartNIC card, according to one embodiment.

### DETAILED DESCRIPTION

Embodiments of methods and apparatus for LAN PCIe bandwidth optimization are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

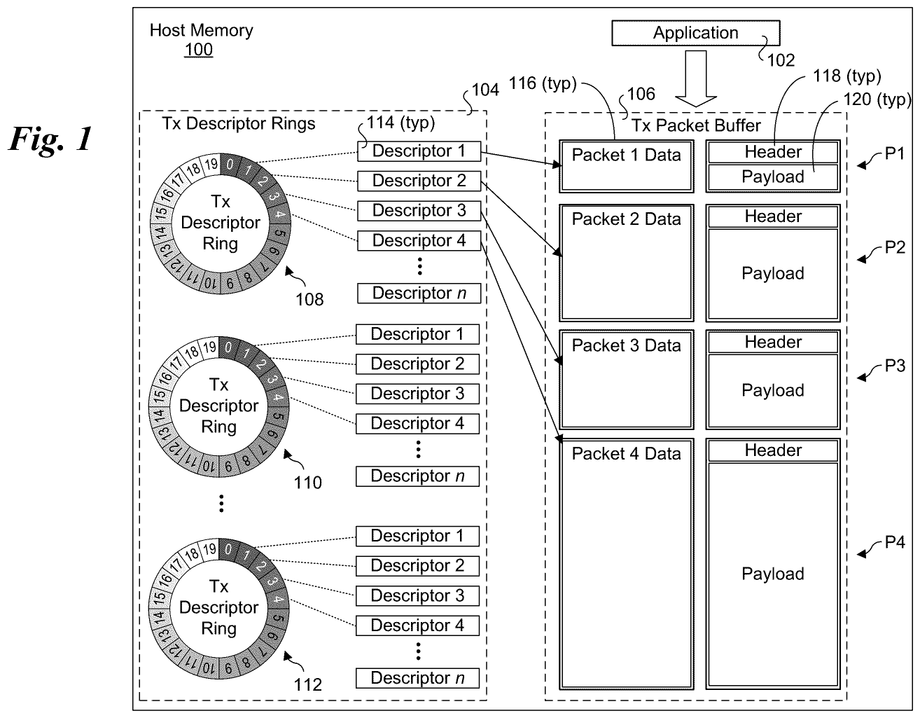

FIG. 1 shows an example of a use of transmit (Tx) descriptors using a current conventional approach. The various components and data structures shown in FIG. 1 are implemented in host memory 100, including an application 102, Tx descriptor rings 104, and a Tx packet buffer 106. Under various host architectures, application 102 may run on a platform operating system (OS), or may run on a guest OS or the like in a virtualized environment including one or more virtual machines (VMs) or containers.

FIG. 1 shows three Tx descriptor rings 108, 110, and 112. Generally, one or more Tx descriptor rings will be allocated by a host entity, such as a host operating system or NIC device driver. The terminology “descriptor ring” is used herein to represent a data structure in memory having multiple slots or entries in which respective descriptors are temporarily buffered. These data structures may also be called ring buffers or circular buffers, or the like. A descriptor ring, ring buffer, or circular buffer may have fixed-size slots or entries or may have may employ a wrap-around linked-list with variable size entries. Each Tx descriptor ring includes a plurality of Tx descriptors 114. For example, each of Tx descriptor rings 108, 110, and 112 include n descriptors, with each descriptor buffered in a respective slot in the ring. In one non-limiting example, n=128, noting the number of slots for a ring may vary depending on the needs for an implementation and/or other criteria. In some implementations, a set of one or more Tx descriptor rings may be implemented for an associated entity and/or component. For example, for a NIC that includes multiple protocol engines (PEs), a set of one or more Tx descriptor rings may be provided for each PE. Under another approach, a set of Tx descriptor rings may be allocated for each of multiple VMs or containers on the host.

In the simplified example shown in FIG. 1, application 102 has written 4 packets 116 to Tx packet buffer 106. The packets are also labeled and referred to herein as ‘P1’, ‘P2’, ‘P3’, and ‘P4’. Each packet 116 includes a header 118 and a payload 120. The combination of the packet header and payload is referred to as “packet data” herein.

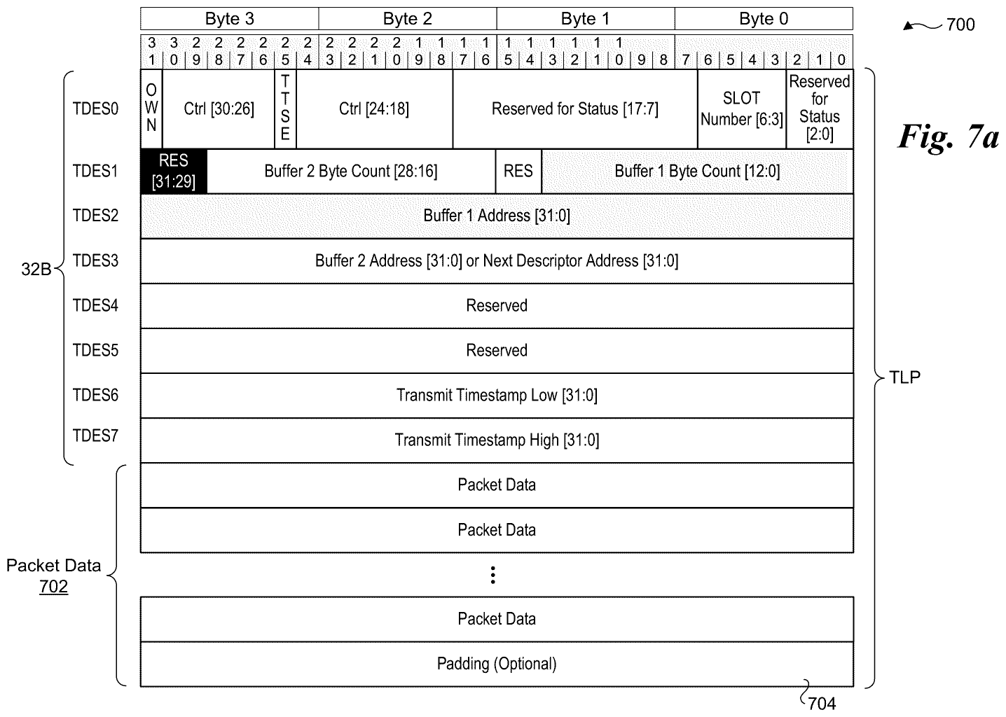

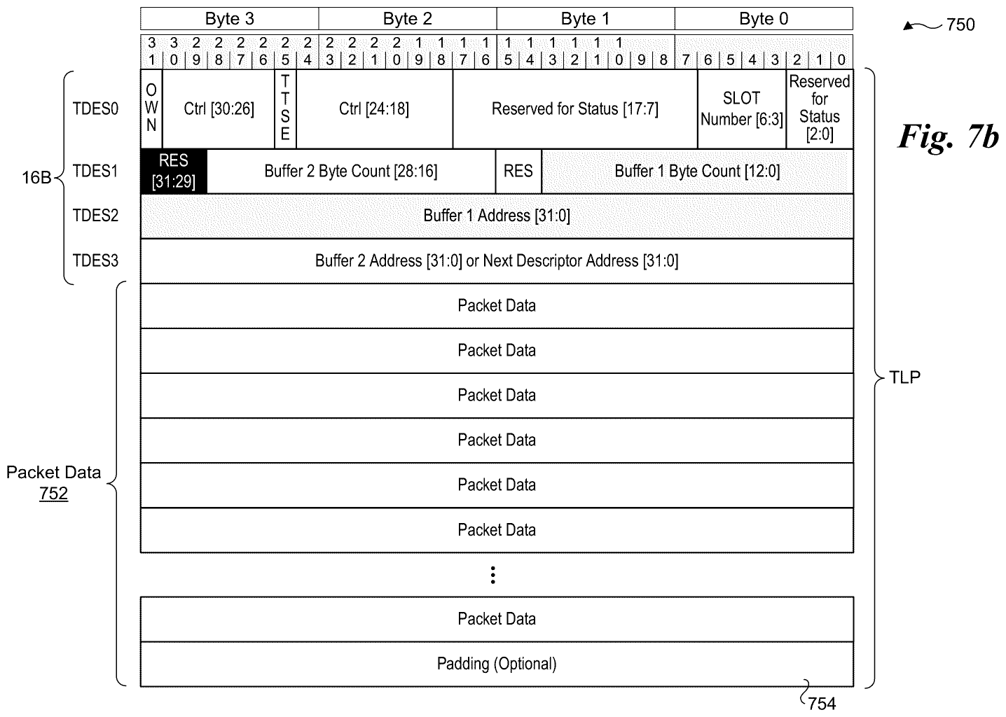

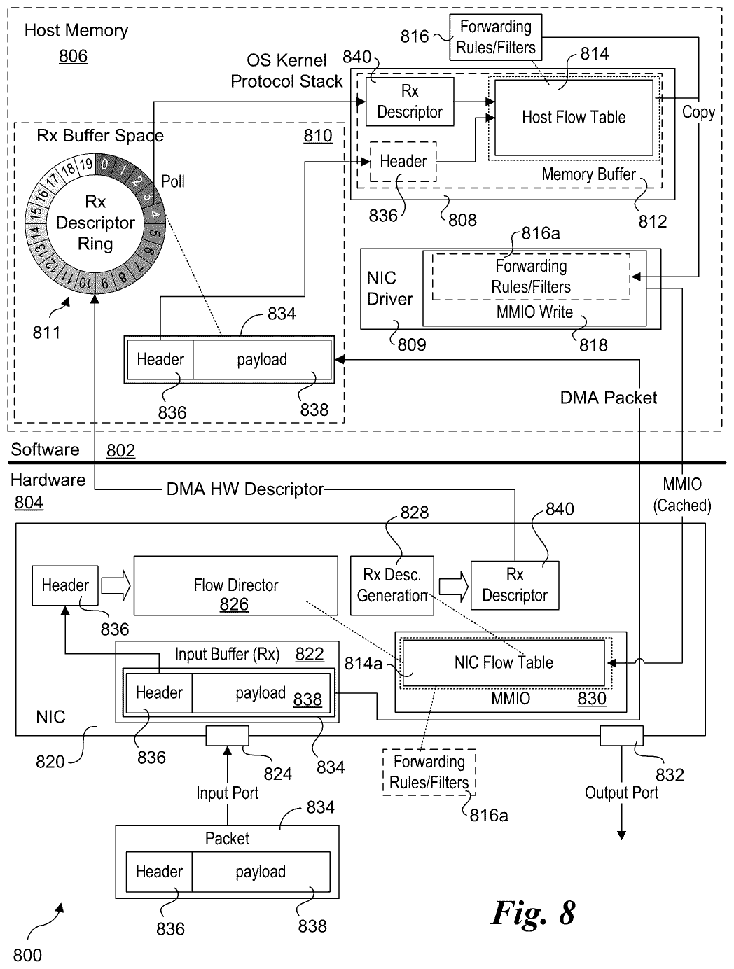

As further shown in FIG. 1, each of the Tx descriptors 1, 2, 3, and 4 for Tx descriptor ring 108 references a respective packet P1, P2, P3, and P4. As is known in the art, Tx descriptors 114 contain information that is used by the NIC PEs to copy packets in Tx packet buffers on the host to memory buffers on the NIC using direct memory access (DMA). Among other data, the descriptors contain information that identifies where the packet associated with a descriptor is buffered in host memory 100, such as described and illustrated below in connection with Tx descriptor structures 700 and 750 of FIGS. 7a and 7b. A NIC PE will “pull” a descriptor off a Tx descriptor ring using a DMA read operation to copy the descriptor into a local descriptor buffer on the NIC. The NIC PE will utilize data in the NIC descriptor to identify wherein the packet data are located in host memory and copy the packet data into a Tx buffer in memory on the NIC using DMA host memory read operations. Under DMA, associated components on the host processor (e.g., a DMA engine) and on the NIC (e.g., I/O (input/output) virtual and/or physical functions) are used to copy the packet data for a given packet into one or more TLPs, which are enqueued in an output port on a PCIe interface on the host and subsequently transferred to an input port on the PCIe interface of the NIC. An I/O virtual or physical function is then used to copy the packet data into a buffer in memory on the NIC.

As described above, a separate TLP will be used to transfer a Tx descriptor from host memory to a Tx descriptor buffer or the like in memory on the NIC that is used by a NIC PE. This is used regardless of the size of the TLP and descriptor. Descriptors may have different sizes depending on what transmit functionality is supported by the platform. For instance, a simple Tx descriptor may comprise 16 Bytes or 24 Bytes, while a more complex descriptor may comprise 32 Bytes, etc. Meanwhile, the TLP size for a PCIe interface is configurable and can be a power of 2 between 64 and 4K (64, 128, 256, 512, 1024, 2048, 4096) Bytes (depending on the PCIe generation supported by the PCIe interface).

Under aspects of the teachings and principles disclosed herein, a Tx descriptor for a packet is augmented to include at least a portion of the packet data for the packet. This provides more efficient utilization of the PCIe interface, including reducing the number of TLPs used to copy packet data from host memory to Tx buffers in NIC memory. Depending on the size of the packet data, in some cases the entirety of the packet data can be combined with the descriptor data in an augmented Tx descriptor, thus only consuming a single TLP. The novel approach also provides more efficient bandwidth utilization when handling packets of various sizes, as demonstrated in the Figures illustrated and described below.

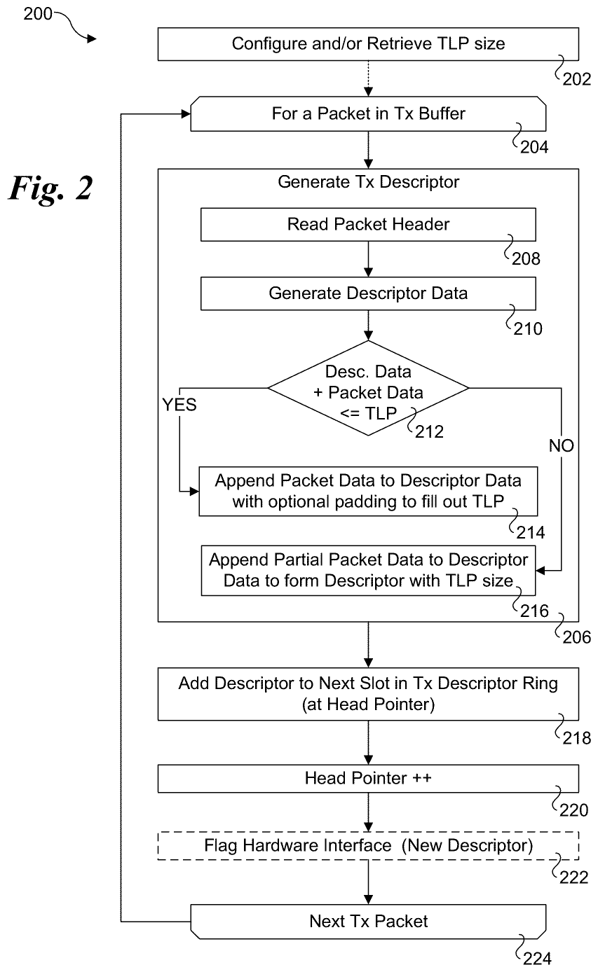

FIG. 2 shows a flowchart 200 illustrating operations for generating Tx descriptors with full or partial packet data, according to one embodiment. In a block 202, the size of the TLP to be used for the PCIe interconnect between the host processor and NIC is set and/or retrieved. The TLP size may be configured during platform initialization as part of PCIe enumeration. The TLP size may be retrieved by reading applicable PCIe interface configuration information. In this non-limiting example, the TLP size is configured to be 128 Bytes.

As shown by start and end loop blocks 204 and 224, the operations depicted between these blocks are performed for each packet in a host Tx buffer for which an associated Tx descriptor is generated. In a block 206, the Tx descriptor is generated. This begins by reading the packet header for the packet in a block 208. The packet header contains information associated with the packet that will be used by the descriptor, and is located at the start address for the packet. As described and illustrated in further detail below, in some embodiments part of the Tx descriptor data will include the starting address of the packet in the Tx buffer or the starting address of the remaining packet data that will be retrieved when the Tx descriptor is processed by the NIC PE. The packet header also contains the length of the packet payload, which also may be used to determine the length of the packet itself.

In a block 210 the Tx descriptor data is generated. As described in further detail below, the descriptor data is similar to the data that is generated for a conventional Tx descriptor and is referred to as “descriptor data” herein to distinguish the portion of the Tx descriptor that will be used for processing the descriptor from the portion of the Tx descriptor comprising packet data. As described below, in one embodiment the Tx descriptor data includes a flag that identifies the descriptor corresponds to a Tx descriptor including packet data. In some embodiments of a NIC, the NIC PEs are configured to work with both conventional Tx descriptors and the novel Tx descriptors with packet data described and illustrated herein. Under an optional implementation, the NIC PEs can determine the difference between a conventional descriptor and a descriptor with packet data by inspecting the descriptor content. Under this approach, the use of a flag is optional.

In a decision block 212 a determination is made to whether the combined size of the descriptor data plus the packet data for the packet is less than or equal to the TLP size. If this is TRUE (answer YES), the entire packet can be transferred along with the descriptor data as part of the Tx descriptor. Accordingly, the logic proceeds to a block 214 in which the packet data are appended to the end of the description data. Under one embodiment, optional padding is used to fill out the Tx descriptor such that its size matches the TLP size.

If the size of the descriptor data plus the packet data is greater than the TLP size, the answer to decision block 212 is NO, and the logic proceeds to a block 216. In this case, at least one additional TLP will be needed to transfer the packet data to the NIC buffer. Accordingly, a portion of the packet data equal to the TLP size minus the descriptor data size is appended to the descriptor data in block 216. In this non-limiting example, the descriptor data is 32 Bytes and the TLP is 128 Bytes, so the first 96 Bytes of packet data is appended to the Tx descriptor data.

Once the Tx descriptor is generated, it is added to a slot in the Tx descriptor ring that is pointed to by the head pointer, as shown in block 218. This may also be referred to as the next slot or next available slot. In one embodiment, software comprising a NIC driver is used to manage the Tx descriptor rings for the platform, which includes allocating buffer space for each Tx descriptor ring and providing associated information to logic on the NIC to coordinate management of the head pointers and tail pointers for each Tx descriptor ring. In connection with adding the descriptor to the next slot, the head pointer is incremented by 1 slot to point to the next slot, in one embodiment, as shown in block 220. As will be recognized by those skilled in the art, when the head pointer or tail pointer reaches a maximum value, incrementing that value returns the head or tail pointer to the start of the Tx descriptor ring data structure (e.g., slot ‘0’ in the diagrams illustrated herein).

As shown in an optional block 222, the hardware interface is flagged to indicate a new descriptor (or otherwise new work) is available. Generally, flagging the hardware interface may occur for a single new descriptor or for a batch of new descriptors. Flagging may comprise setting a flag or may provide more detailed information, such as identifying which Tx descriptor ring has new work and/or identifying which PE the new work is for. In some embodiments the hardware (e.g., NIC or NIC PE) may perform polling of the hardware interface to see if any new work is available. Optionally, an interrupt-type mechanism may be used.

This completes generation of the Tx descriptor and associated operations on the host side for the packet. The logic then returns from end loop block 224 to start loop block 204 to generate a Tx descriptor for the next packet.

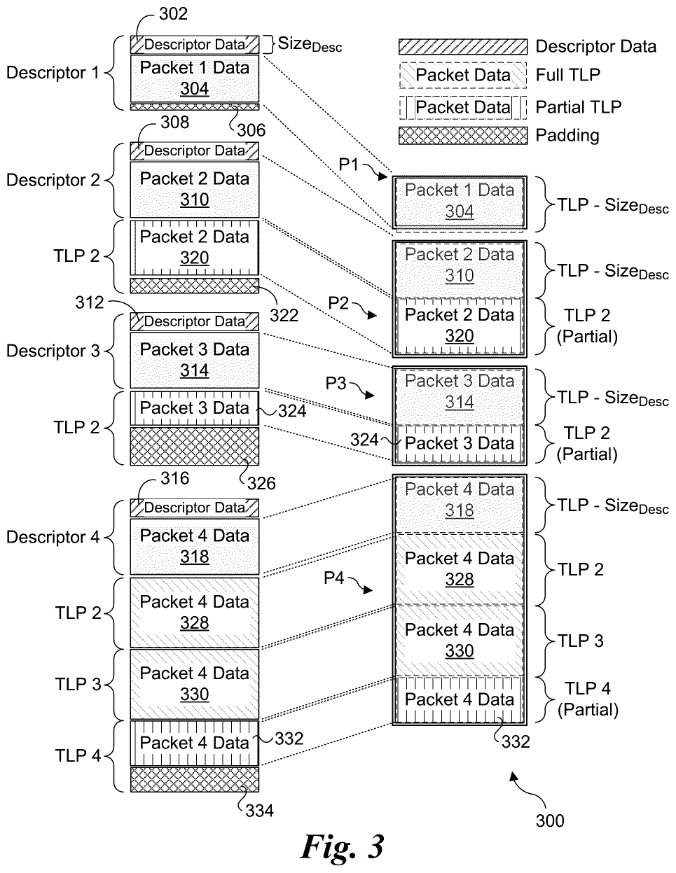

Diagram 300 of FIG. 3 schematically depicts how the packet data are partitioned and the structure of the associated Tx descriptors for each of packets P1, P2, P3, and P3, where the associated Tx descriptors are labeled Descriptor 1, Descriptor 2, Descriptor 3, and Descriptor 4. Packet P1 has a size that is less than a TLP minus the descriptor data size (Size_{Desc}). Accordingly, Descriptor 1 includes descriptor data 302 to which Packet 1 data 304 is appended. Since this combined size is less than the TLP size, optional padding 306 is added such that the size of Descriptor 1 is equal to the size of a TLP.

Descriptor 2 is associated with packet P2, which has a size that is greater than a TLP−Size_{Desc}. Accordingly, when generating Descriptor 2 the logic will proceed to block 216, where a first portion of packet P2 having a size of TLP−Size_{Desc} (e.g., 96 Bytes) will be added to descriptor data 308, as depicted by packet 2 data 310.

Descriptor 3 is associated with packet P3, which also has a size that is greater than a TLP−Size_{Desc}. Accordingly, when generating Descriptor 3 the logic will proceed to block 216, where a first portion of packet P3 having a size of TLP−Size_{Desc} (e.g., 96 Bytes) will be added to descriptor data 312, as depicted by packet 3 data 314.

Descriptor 4 is associated with packet P4, which also has a size that is greater than a TLP−Size_{Desc}. As before, when generating Descriptor 4 the logic will proceed to block 216, where a first portion of packet P4 having a size of TLP−Size_{Desc} (e.g., 96 Bytes) will be added to descriptor data 316, as depicted by packet 3 data 318.

Diagram 300 further depicts additional (remaining) portions of packets P2, P3, and P3, along with the additional TLPs used to transfer the packet data for these packets to a Tx buffer in NIC memory. For packet P2, remaining packet 2 data 320 comprising a partial TLP will be DMA'ed from its location in the Tx packet buffer, along with optional padding 322 to fill out the second TLP 2. For packet P3, remaining packet 3 data 324 comprising a partial TLP will be DMA'ed from its location in the Tx packet buffer, along with optional padding 326 to fill out the second TLP 2. For packet P4, remaining packet 3 data 328 and 330 comprising respective TLP 2 and 3 and packet 3 data 332 comprising a partial TLP will be DMA'ed from its location in the Tx packet buffer, along with optional padding 334 to fill out the fourth TLP 4.

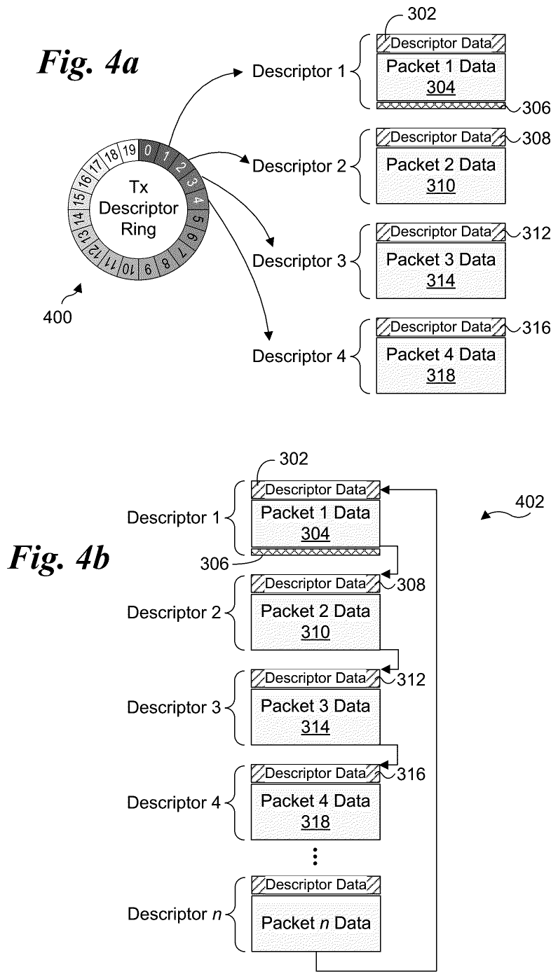

FIGS. 4a and 4b show respective schemes for buffering Tx descriptors, according to respective embodiments. Under the scheme in FIG. 4a, all Tx descriptors have a fixed size that is equal to a TLP, with respective Tx descriptors 1, 2, 3, and 4, occupying respective slots 1, 2, 3, and 4 on Tx descriptor ring 400. As described above, in one embodiment the TLP size is 128 Bytes.

FIG. 4b shows a linked list 402 having n Tx descriptors 1, 2, 3, 4 . . . n. Under one embodiment of the linked list, Tx descriptors having a size less than a TLP can be buffered in a link list entry having a size that is less than a TLP. The start of a next Tx descriptor follows the end of a prior Tx descriptor, in one embodiment.

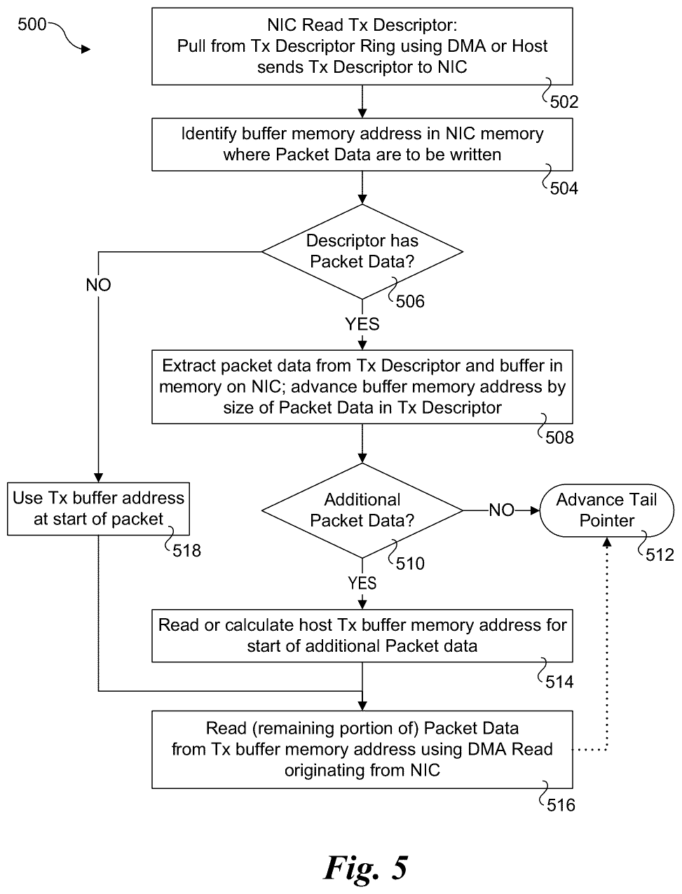

FIG. 5 shows a flowchart 500 illustrating operations performed by a NIC or NIC PE to pull Tx descriptors of a Tx descriptor ring, extract the packet data, and DMA remaining packet data in a Tx packet buffer, as applicable, to regenerate a copy of the packet in a Tx buffer (aka an egress or output buffer) in NIC memory.

The process begins in a block 502 in which the NIC (or NIC PE) reads a Tx descriptor. This can be accomplished using different techniques. For example, in one embodiment the NIC/NIC PE will “pull” a descriptor off the Tx descriptor ring using a DMA read operation. As described and illustrated in further detail below, the NIC/NIC PE employs data structures, such as a copy of the Tx descriptor ring implemented on the host or other data structure, to track the work it has performed associated with Tx descriptors that have been added to a given Tx descriptor ring. In one embodiment, this includes a tail point that is used to point to the next Tx descriptor that is to be processed by the NIC/NIC PE. The NIC/NIC PE will then initiate a DMA read of the Tx descriptor at the address associated with the tail pointer. Further discussion of how the address of the tail pointer may be determined is provided below.

Under an optional scheme, Tx descriptors may be sent from the host to the NIC or a NIC PE to a buffer or write a DMA descriptor to a Tx descriptor ring for the NIC or NIC PE. For the operations in block 502, the NIC/NIC PE would read the Tx descriptor from where it is written to by the host. Similar to DMA read operations originating from the NIC, the host may employ a DMA write to write data to a memory on the NIC. For example, memory on the NIC may comprise memory-mapped IO (MMIO) memory.

In a block 504 the buffer memory address in NIC memory where the packet data are to be buffered is identified. Generally, management of buffers employed by a NIC or NIC PE may be managed by the NIC/NIC PE, by the host, or both. For example, the host (e.g., via the NIC driver running on the host) may allocate memory spaces in the NIC memory to be used, with the NIC/NIC PE controlling where in the allocated memory spaces the buffers are located. Optionally, the host may allocate buffer spaces for individual NIC PEs (when there is more than one PE), either as a whole or at a more granular level, such as allocating buffer spaces for individual applications running on the host.

Next, in a decision block 506 a determination is made to whether the descriptor includes packet data. As discussed above, in some embodiments the NIC is configured to handle both the new Tx descriptors with packet data disclosed herein and conventional Tx descriptors. Determining whether the descriptor includes packet data may be done by inspection or a flag in the descriptor may be used. If packet data are present, the answer to decision block 506 is YES and the logic proceeds to a block 508 in which the packet data are extracted from the Tx descriptor and buffered in memory at the buffer memory address identified in block 504. The buffer memory address is then advanced by the size of the packet data in the Tx descriptor.

In a decision block 510 a determination is made to whether there is additional packet data that need to be read for the packet. If all the packet data are included in the Tx descriptor, the answer to decision block is NO and the logic proceeds to an end block 512 in which the tail pointer for the Tx descriptor ring is advanced. Generally, advancement of the tail pointer may be made when reading all the packet data for individual packets are completed, or for a burst of packets. For example, since updating the tail pointer for the Tx descriptor ring maintained on the host requires transferring data over the PCIe interface (and thus will consume a TLP), it may be more efficient to provide an indication at which slot the tail pointer should be advanced to after a batch of packets has been read. The software (e.g., NIC driver) on the host will not overwrite Tx descriptor ring data for slots between the tail point and the head pointer, recognizing the software writes new descriptors at the head and the NIC reads descriptors from the tail.

It is noted that under an alternative implantation, different data structures may be used such as a work completion queue. When the NIC completes work it updates the work completion queue with indicia identifying what Tx descriptor(s) have been processed. The host can periodically read the completion queue on the NIC or the completion data may be DMA'ed by the NIC to a work completion queue maintained on the host. The host can then use data in the work completion queue to advance the tail pointer for a Tx descriptor and/or to otherwise determine there are slots in the Tx descriptor ring that may be overwritten with new descriptors. Other mechanisms, such as Tx descriptor writeback, may be used for coordinating the use of Tx descriptor rings on the host and on the NIC.

If the are additional packet data to be read the answer to decision block 510 is YES, and the logic proceeds to a block 514 in which the host Tx buffer memory address for the first TLP packet of additional data is either read from the Tx descriptor or calculated based on memory address information in the Tx descriptor. For example, a conventional Tx descriptor will include the Tx buffer memory address identifying the location in host memory where the start of the packet begins. When this scheme is used by a Tx descriptor with packet data, the size of the packet data included in the Tx descriptor can be determined, and the buffer memory address is offset by that size to calculate the host Tx buffer memory address at which the start of the additional packet data begins. Optionally, the Tx buffer memory address may be explicitly included in the Tx descriptor, such as in place of where the start of the packet would normally be written (e.g., in the same field in the Tx descriptor), as described below in connection with Tx descriptor structure 700 and 750 of FIGS. 7a and 7b.

Following the operations of block 514, the remaining portion of packet data that was not included in the Tx descriptor is read from the Tx memory buffer in the host using a DMA read transfer originating from the NIC. This may internally comprise one or more TLPs worth of data being transferred over the PCIe interface, with the DMA transfer facilitated by applicable logic on the host processor and on the NIC. This completes reading of the packet data, followed by the logic proceeding to end block 512 to advance the tail pointer (or otherwise to update a completion queue or the like).

When the Tx descriptor does not include packet data it is handed by the NIC as a conventional Tx descriptor in the normal manner. In this case, the answer to decision block 506 is NO and the Tx buffer address for the start of the packet is included in the Tx descriptor and read in a block 518. The process then proceeds to block 516, where a DMA read employs the start of packet Tx buffer memory address to read the entirety of the packet data in the conventional manner.

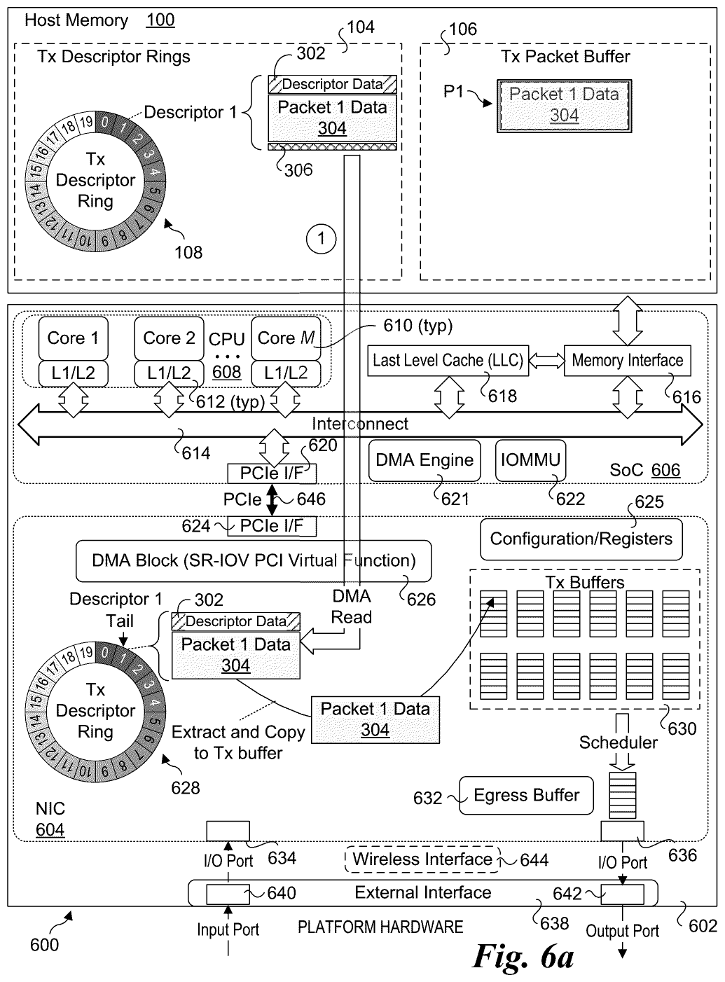

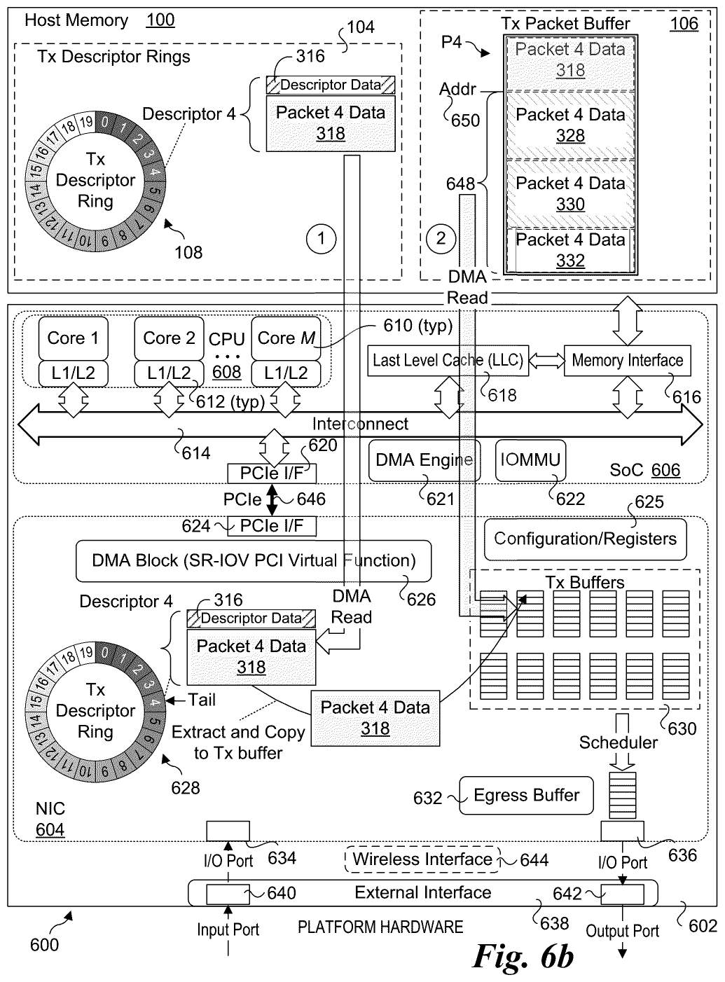

FIGS. 6a and 6b show exemplary data flows for transferring packets P1 and P2 to Tx buffers on a NIC using a computing platform 600. The platform hardware 602 includes a NIC 604, a processor/SoC (System-on a Chip) 606, and host memory 100. SoC 606 components include a central processing unit (CPU) 608 having M cores 610, each associated with an L1/L2 cache 612, the L1/L2 caches and various other components are coupled to an interconnect 614, including a memory interface 616, a last level cache (LLC) 618, and a PCIe interface (I/F) 620. SoC 606 also includes a DMA engine 621 and an Input-Output Memory Management Unit (IOMMU) 622. As will be recognized by those skilled in the art, SoC 606 will include other components and interfaces that are not shown for simplicity and clarity. Additionally, interconnect 614 is illustrative of multiple internal interconnect structures in SoC 606

NIC 604 is illustrative of a network controller or network device, and includes a PCIe interface 624, a configuration/registers block 625, a DMA block 626, a Tx descriptor ring 628, a plurality of Tx buffers 630, an egress queue or buffer 632, and I/O ports 634 and 636, which support a single network port. Platform hardware 602 may include an external interface 638 including an input port 640, and an output port 642. Platform hardware 602 may also include an optional wireless interface 644 (e.g., a wireless local area network (WLAN) interface, such as an IEEE 802.11-based wireless interface) that supports network communication using wireless signals. PCIe interface 624 is connected to PCIe interface 620 via a PCIe interconnect 646.

While input port 640 and output port 642 are shown as separate ports, they may be implemented as a single physical port, such as an RJ45 port. When NIC 604 is implemented as a network adaptor card or the like, inputs and output ports 640 and 642 may be included on the card rather than employ an external interface. While a single pair of I/O ports are shown, a NIC or network adaptor may support multiple network ports. Under some platforms, such as laptops or notebooks that include one or more USB-C ports, communication with a wired network may be facilitated by USB chip that, in turn, coupled to an external USB-C device that has one or more physical network ports, such as an RJ45 port.

With reference to flowchart 500 of FIG. 5 discussed above, the data flow for transferring a copy of packet P1 to a Tx buffer 630 proceeds as follows. In block 502, Tx descriptor 1 is pulled from Tx descriptor ring 108 in host memory 100 using a DMA read transaction originating from NIC 604. In the illustrated example, NIC 604 implements a Tx descriptor ring 628 that mirrors Tx descriptor ring 108. It is noted that this is merely one example approach, as a NIC may employ other data structures for managing workflow, such as other types of circular buffers and queues that may have a different number of slots or entries than the data structures used by the host. Under one embodiment, NIC 604 tracks progress using a tail pointer, while the network driver or other software (both not shown) running on the host manages Tx descriptor ring 108 with both a head and tail pointer. Other work tracking mechanisms may also be employed. Various parameters for setting up and managing workflows (and associated data structures) may be stored in configuration/registers block 625, which may be programmed by software on the host, such as but not limited to a NIC driver).

In this example, the current position of the tail pointer for Tx descriptor ring 628 is slot 1. Accordingly, NIC 604 originates a DMA read request to access the Tx descriptor in slot 1 of Tx descriptor ring 108. The platform uses a combination of DMA engine 621, IOMMU 622 and DMA block 626 to facilitate the DMA transfer, as is known in the art. In the illustrated example, DMA block 626 comprises a single-root I/O virtualization (SR-IOV) PCI virtual function. This is merely exemplary and non-limiting, as DMA functionality may be facilitated between a host and a NIC or network adaptor using one or more virtual or physical functions, as is known in the art.

Under the illustrated DMA read transaction, a copy of Tx descriptor 1 is buffered in slot 1 of Tx descriptor ring 628. In block 504, logic implemented on NIC 604, such as in a PE (not separately shown) will identify a buffer memory address corresponding to a Tx buffer 630 where the packet data are to be written. For simplicity, a single set of Tx buffers is shown. In practice there may be multiple sets of Tx buffers that may, for example, be assigned to different traffic classes and/or assigned to associated output ports. The logic will inspect the descriptor and determine in decision block 506 that the descriptor includes packet data. In accordance with block 508, the logic will then extract the packet data (304) from the Tx descriptor and copy it into a Tx buffer beginning at the buffer memory address identified in block 504. The logic will then advance the buffer memory address by an offset equal to the size of the packet data (304). In some embodiments, thus advancement of the buffer memory address is optional when all the packet data are included in the descriptor.

Continuing at decision block 510, since all the packet data are included in Tx descriptor 1, there is no additional packet data for packet P1 and the logic proceeds to end block 512 to advance the tail pointer for Tx descriptor ring 628.

Turning to FIG. 6b, in this example the DMA read transactions for packet P4 are shown. Prior to this, each of Tx descriptors 2 and 3 for packets P2 and P3 will have been read and processed to copy the packet data for packets P2 and P3 into Tx buffers 630, at this point the tail pointer for Tx descriptor ring 628 will be at slot 4. The DMA read transaction for Tx descriptor 4 is similar to Tx descriptor 1 in FIG. 6b, with the difference being the destination (slot 4 vs. slot 1) and the different data in the two descriptors. A difference is in decision block 510 the answer will be YES since there is additional packet data, which comprises the remaining portion 648 of packet data that is not included in Tx descriptor 4. Remaining portion 648 includes packet 4 data 328, 330, and 332. In block 514 the Tx buffer memory address 650 corresponding to the start of remaining portion 648 (the additional packet data) is read or calculated based on information in Tx descriptor 4. For example, memory address 650, reach corresponds to the start of packet 4 data 328, may be explicitly provided in Tx descriptor 4, or this memory address can be derived from information in Tx descriptor, such as the memory address of packet P4+an offset equal to the size of packet 4 data 318 that is included in Tx descriptor 4.

In block 516 the remaining portion 648 of packet data for packet P4 is read using a DMA read transaction referencing memory address 650 and the size of remaining portion. The destination address will correspond to the memory address that was advanced in block 508. This will enable remaining portion 648 to be appended to packet 4 data 318, thus recreating packet P4 in one of Tx buffers 630. This is shown as DMA read transaction 2 in FIG. 6b.

FIGS. 7a and 7b show examples of Tx descriptor structures 700 and 750, according to respective embodiments. In FIGS. 7a and 7b, TDES0, TDES1 . . . etc., are DWORD portions of the Tx descriptor structures. The DMA logic reads or fetches the four DWORDS of the Tx descriptor from host memory to obtain buffer and control information.

The fields in Transmit Descriptor Word 0 (TDES0) are used to provide various control, error, and status information of which only selective bits are discussed herein as the remaining bits in the fields in TDES0 are known in the art and outside the scope of this disclosure. OWN bit 31 is a bit that indicates whether the descriptor is owned by the DMA or owned by the Host. The DMA clears this bit either when it completes the frame transmission or when the buffers allocated in the descriptor are read completely.

TTSS is the Transmit Timestamp Status bit. This field is used as a status bit to indicate that a timestamp was captured for the described transmit frame. When this bit is set, TDES2 and TDES3 have a timestamp value captured for the transmit frame. This field is only valid when the descriptor's Last Segment control bit (TDES0[29]) is set.

Details for conventional uses of Transmit Descriptor Words 1, 2, 3, 6, and 7 (TDES1, TDES2, TDES3, TDES6, and TDES7) are shown in the following Tables.

TABLE 1
(DES1)

| Bit | Description |
|---|---|
| 31:29 | Reserved |
| 28:16 | TBS2; Transmit Buffer 2 Size |
| | This field indicates the second data buffer size in bytes. This field is not valid if |
| | TDES0[20] is set. |
| 15:13 | Reserved ^{†} |
| 12:0 | TBS1: Transmit Buffer 1 Size |
| | This field indicates the first data buffer byte size, in bytes. If this field is 0, the DMA |
| | ignores this buffer and uses Buffer 2 or the next descriptor, depending on the value |
| | of TCH (TDES0[20]). |

TABLE 2
(DES2)

| Bit | Description |
|---|---|
| 31:0 | Buffer 1 Address Pointer |
| | These bits indicate the physical address of Buffer 1. There is no |
| | limitation on the buffer address alignment. |

TABLE 3
(DES3)

| Bit | Description |
|---|---|
| 31:0 | Buffer 2 Address Pointer (Next Descriptor Address) |
| | Indicates the physical address of Buffer 2 when a descriptor ring structure is used. If |
| | the Second Address Chained (TDES0[20]) bit is set, this address contains the pointer |
| | to the physical memory where the Next descriptor is present. The buffer address |
| | pointer must be aligned to the bus width only when TDES0[20] is set. (LSBs are |
| | ignored internally.) |

TABLE 4
(DES6)

| Bit | Description |
|---|---|
| 31:0 | TTSL: Transmit Frame Timestamp Low |
| | This field is updated by DMA with the least significant 32 bits of the timestamp |
| | captured for the corresponding transmit frame. This field has the timestamp only if |
| | the Last Segment bit (LS) in the descriptor is set and Timestamp status (TTSS) bit is |
| | set. |

TABLE 5
(DES7)

| Bit | Description |
|---|---|
| 31:0 | TTSH: Transmit Frame Timestamp High |
| | This field is updated by DMA with the most significant 32 bits of the timestamp |
| | captured for the corresponding receive frame. This field has the timestamp only if |
| | the Last Segment bit (LS) in the descriptor is set and Timestamp status (TTSS) bit is |
| | set. |

Timestamps may be used to prevent race conditions, but are optional under some embodiments. The descriptor data portion of Tx descriptor structure 750 in FIG. 7b comprises 4 DWORD (16 Bytes), which does not include TDES4, TDES5, TDES6, and TDES7. When the advanced timestamp feature is enabled, software should set Bit 7 of Register 0 (Bus Mode Register), so that the DMA operates with extended descriptor size. When this control bit is clear, the TDES4-TDES7 descriptor space is not valid.

Under Tx descriptor structure 700, the first 32 Bytes comprise the descriptor data, and the remaining portion of the data comprise packet data 702. When the packet data is less than the TLP size minus the descriptor data size, padding 704 may be added to fill out the TLP. Under Tx descriptor structure 750, the first 16 Bytes comprise the descriptor data, and the remaining portion of the data comprise packet data 752. When the packet data is less than the TLP size minus the descriptor data size, padding 754 may be added to fill out the TLP.

Under conventional usage of the Tx descriptor data fields, bits [31:29] are reserved. Conversely, under embodiments of Tx descriptor structures 700 and 750, one or more of theses bits may be used to mark the descriptor to identify the Tx descriptor includes packet data and/or to identify the Tx descriptor includes a portion of the packet data for the packet and that additional packet data are buffered in host memory. For example, a single bit may be used to mark the Tx descriptor as including packet data. A second bit could be used to indicate whether all the packet data are included in the Tx descriptor or only a portion of the packet data are included in the Tx descriptor.

The Buffer 1 Address and Buffer 1 Byte Count fields may be used in different ways under different embodiments. Normally (under conventional usage), the Buffer 1 Address is the address of the packet in host/system memory, and Buffer 1 Byte Count is the size of the packet. However, since a portion of the packet data is included in the Tx descriptor that portion of packet data does not need to be retrieved in a subsequent DMA read operation. If all the packet data is included in the Tx descriptor, there is no need for a subsequent DMA read operation. As discussed above, a flag (e.g., one of bits 29, 30, 31 in TDES1) can be used to indicate this condition. The logic on the NIC/NIC PE can detect the flag and then ignore the data in the Buffer 1 Address and the Buffer 1 Byte Count fields, since those fields will not be used.

Now consider situations where only a portion of the packet data is included in the Tx descriptor, and the remaining packet data will be read using a DMA read operation. Under one embodiment, the Buffer 1 Address is the memory address in host memory at which the start of the remaining packet data is located and the Buffer 1 Byte Count is the size of the remaining portion of packet data. Under another approach, the Buffer 1 Address and Buffer 1 Byte Count values are the conventional values. Meanwhile, the NIC/NIC PE logic can determine that a portion of the packet has already been transferred. The logic can then determine the memory address offset at where the start of the remaining packet data are located by adding the size of the partial packet data included Tx descriptor to the Buffer 1 Address. The size of the remaining packet data can be determined by subtracting the size of the packet data in the Tx descriptor from the Buffer 1 Byte Count.

In one embodiment, Buffer 2 Address or Next Descriptor Address is used for the Next Descriptor Address in the conventional manner, with Buffer 2 Byte Count used for defining the size of the Next Descriptor Address. For example, this approach is useful when the size of the Tx descriptor may vary, such as when the packet data for the full packet in combination with the descriptor data is less than a TLP and padding is not used when the Tx descriptor is stored in a circular linked list. Alternatively, for embodiments that employ Tx descriptor slots having a fixed size equal to a TLP, logic on the NIC/NIC PE can manage the current position of the Tx descriptor ring by advancing the tail by a slot when a Tx descriptor has been processed. In this case, all of the size of the Tx descriptor slots and the number of Tx descriptors, and the memory address of slot 0 (start of ring) will be known (e.g., programmed by the NIC driver running on the host), thus the position of the tail pointer and the associated memory address can be managed without having to explicitly inform the NIC/NIC PE of the memory address for the next Tx descriptor (Next Descriptor Address).

The computing systems/platforms/devices are also configured to implement packet receive workflows. FIG. 8 shows a system architecture 800 that may be used to implement aspects of workflows for received packets. System architecture 800 is logically partitioned into a software layer 802 and a hardware layer 804. Software layer 802 includes host memory 806 in which various software components are loaded prior to execution, such as during booting of a host platform and/or during ongoing runtime operations. Host memory 806 is also used to store data structures associated with the software and buffer various data, such as packet data. Some of the other components include operating system (OS) software blocks, including an OS kernel protocol stack 808 and a NIC driver 809.

OS kernel protocol stack 808 includes a software network stack that comprises various components for implementing software processing of Open System Interconnection (OSI) reference Layer 3 and above, in some embodiments. Under one non-limiting approach implemented by Linux OS, the kernel device driver for a NIC maps the hardware receive (Rx) descriptor ring in the NIC hardware, to a portion of host memory comprising Rx buffer space 806, via MMIO access, to facilitate further communication between NIC hardware and NIC device driver over these Rx descriptors. Rx buffer space stores one or more Rx descriptor rings having Rx descriptors carrying metadata about a particular packet and memory pointers to the actual packet header and packet payload information. As illustrated in architecture 800, Rx buffer space 810 includes an Rx descriptor ring 811 whose operation is described below. Typically, for every packet queue it maintains, the NIC device requires one transmit ring buffer for sending packets out of the system, and one receive ring buffer for accepting packets into the system from the network. Under a virtualized embodiment, separate ring buffers and descriptor rings may be allocated for separate OS instances running on virtual machines (VMs) or in containers in a similar manner illustrated in FIG. 8 and described herein.

OS kernel protocol stack 808 includes a memory buffer 812 in which a host flow table 814. Host flow table 814 includes a set of forwarding rules and filters 816 that are used for various operations described herein, including packet/flow classification, forwarding, and other actions.

In the embodiment illustrated in system architecture 800, NIC driver 809 includes MMIO write block 818 that is used write information to communicate the selected entries of the host flow table 814 to be cached in a NIC flow table 814a on a NIC 820 in hardware layer 804.

NIC 820 is generally representative of a network hardware device that is used for performing hardware-based packet-processing operations associated with receiving packets from and transmitting packets to one or more networks to which ports on the NIC are connected. NIC 820 includes an input buffer 822 coupled to an input port 824. Although only a single input port 824 is shown, a NIC may include multiple input ports 824, each coupled to a respective input buffer 822. NIC 820 further includes a flow director block 826, an Rx descriptor generation block 828, MMIO address space 830, and one or more output ports 832. During ongoing operations, selected entries from host flow table 814 are cached in a NIC flow table 814a via MMIO address space 830. In one embodiment, the selected entries are written to MMIO address space 830 via MMIO write block 818 in NIC driver 809. Optionally, another software component (not shown) may be used to write selected entries from host flow table 814 into NIC flow table 814a via MMIO block 830. As another option, the selected flow table entries are written to a portal address in MMIO address space 830, read from the portal address by logic on NIC 820, and cached in NIC flow table 814a.

A packet 834 including a header 836 and payload 838 is received at an input port 824 and buffered in an input buffer 822. Header 836 is extracted and processed by flow director 826 using packet flow information contained in NIC flow table 814a. Depending on whether there is a matching entry in NIC flow table 814a and what the forwarding rule/filter for that entry says to do, flow director may forward the workflow processing to Rx descriptor generation block 828. If so, an Rx descriptor 840 is generated and DMA'ed (using a DMA Write operation) into a slot in Rx descriptor ring 811. A copy of packet 834 is also DMA'ed using a DMA Write operation into a buffer in host memory 806.

The OS kernel protocol stack 808 uses polling to check to see if there have been any new Rx descriptors added to Rx descriptor ring 811. It pulls Rx descriptor 840 off the ring and inspects an address field to locate where in host memory 806 packet 834 is buffered and inspects header 836. Information in Rx descriptor 840 and header 836 are then used to perform a lookup for a match in host flow table 814. If a match is found, the packet is handled in accordance with any rules defined for the matching entry in host flow table 814. If a match is not found, packet 834 belongs to a new flow and a new flow table entry is created and added to host flow table 814.

Periodically, a portion of host flow table 814 is copied to forwarding rules/filters 816a, which in turn are copied via a MMIO Write to NIC flow table 814a, thereby caching a portion of host flow table 814 on the NIC. This enables the handling of some packets to be entirely offloaded to NIC 820. For example, if a matching forwarding rule or filter says to forward the packet to another network address (which might be on the same network or a different network), the packet header will be updated with a new destination address and the packet be sent outbound to that network via an application output port, such as output port 832. In other instances, a matching forwarding rule or filter may say to drop the packet.

Generally, the hardware devices disclosed herein may include but are not limited to network adapters, network controllers or NICs, InfiniBand HCAs, and host fabric interfaces (HFIs). Under some embodiments, the network adaptors, controllers, and NICs are configured to be implemented using one or more Ethernet protocol defined by IEEE 802.3-based protocols. Other types of protocols may also be used, as will be recognized by those having skill in the networking arts.

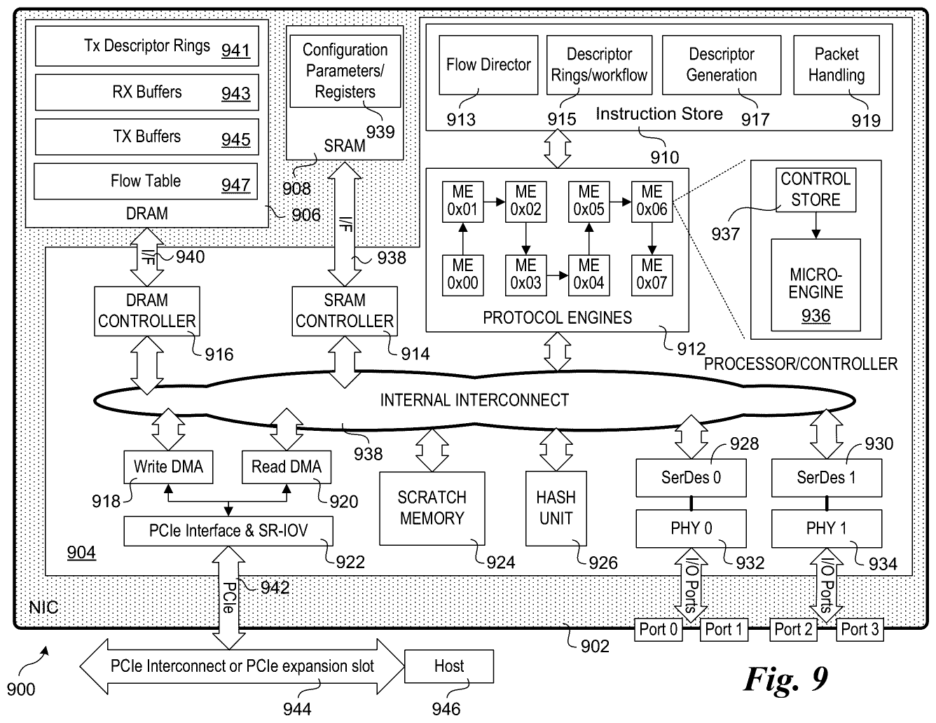

An exemplary system architecture for a NIC 900 is shown in FIG. 9. NIC 900 includes a NIC system board 902 on which a network processor/controller 904 and memory including Dynamic Random Access Memory (DRAM) 906 and Static Random Access Memory (SRAM) 908 are mounted. Under various embodiments, NIC system board 902 is representative of an Ethernet controller card, a daughter board, a multi-chip module board or substrate, or it may be part of a computer system board, such as a main board or motherboard for a computer server. Processor/controller 904 is representative of Ethernet processing and/or control unit, and may be embodied in various forms, including as an Ethernet controller chip or a network processor unit (NPU). Thus, in the following claims, a NIC or network apparatus may comprise an add-on PCIe card, a daughter board, a multi-chip module board, or may comprise just an Ethernet controller chip (e.g., NIC chip), NPU, or network adapter chip.

In the illustrated embodiment, processor/controller 904 includes an instruction store 910, a cluster of protocol engines 912, an SRAM controller 914, a DRAM controller 916, a Write DMA block 918, a Read DMA block 920, a PCIe interface 922, a scratch memory 924, a hash unit 926, Serializer/Deserializers (SerDes) 928 and 930, and PHY interfaces 932 and 934. Each of the components is interconnected to one or more other components via applicable interconnect structure and logic that is collectively depicted as an internal interconnect cloud 938.

Instruction store 910 includes various instructions that are executed by protocol engines cluster 912, including Flow Director instructions 913, descriptor rings and workflow instructions 915, Descriptor Generation instructions 917, and Packet Handling instructions 919. Protocol engines cluster 912 includes a plurality of microengines 936, each coupled to a local control store 937. Under one embodiment, various operations such as packet identification and flow classification are performed using a pipelined architecture, such as illustrated in FIG. 9, with each microengine performing an associated operation in the pipeline. As an alternative, protocol engines cluster 912 is representative of one or more processor cores in a central processing unit or controller. As yet another option, the combination of protocol engines 912 and instruction store 910 may be implemented as embedded logic, such as via a Field Programmable Gate Arrays (FPGA) or the like.

In one embodiment, instruction store 910 is implemented as an on-chip store, such as depicted in FIG. 9. Optionally, a portion or all the instructions depicted in instruction store 910 may be stored in SRAM 908 and accessed using SRAM controller 914 via an interface 938. SRAM 908 may also be used for storing selected data and/or instructions relating to packet processing operations. In the illustrated embodiment, configuration parameters and registers 939 are implemented in SRAM.

DRAM 906 is used to store Tx descriptor rings 941, Input (Rx) Buffers 943, output (Tx) Buffers 945, and flow table 947, as well as various other buffer and/or queues (not separately shown), and is accessed using DRAM controller 916 via an interface 940. Write DMA block 918 and Read DMA block 920 are respectively configured to support DMA Write and Read operations in accordance with the embodiments described herein. In the illustrated embodiment, DMA communication between SRAM 908 and a platform host circuitry is facilitated over PCIe interface 922 via a PCIe link 942 coupled to a PCIe interconnect or PCIe expansion slot 944, enabling DMA Write and Read transactions between SRAM 908 and system memory for a host 946 using the PCIe protocol. Portions of DRAM 906 may also be accessed via DMA Write and Read transactions. PCIe interface may operate as a PCIe endpoint supporting SR-IOV functionality under some embodiments.

Scratch memory 924 and hash unit 926 are illustrative of components employed by NICs for facilitating scratch memory and hashing operations relating to packet processing. For example, as described above a hash operation may be implemented for deriving flow IDs and for packet identification. In addition, a hash unit may be configured to support crypo-accelerator operations.

PHYs 932 and 934 facilitate Physical layer operations for the NIC, and operate as a bridge between the digital domain employed by the NIC logic and components and the analog domain employed for transmitting data via electrical, optical or wired signals. For example, in the illustrated embodiment of FIG. 9, each of PHYs 932 and 934 is coupled to a pair of I/O ports configured to send electrical signals over a wire cable such as a Cat6e or Cat6 Ethernet cable or a 1, 10, or 100 GB Ethernet cable. Optical and wireless signal embodiments would employ additional circuitry and interfaces for facilitating connection via optical and wireless signals (not shown). In conjunction with PHY operations, SerDes 928 and 930 are used to serialize output packet streams and deserialize inbound packet streams.

In addition to the instructions shown in instruction store 910, other instructions may be implemented via execution of protocol engines 912 or other processing means to facilitate additional operations. For example, in one embodiment, NIC 900 is configured to implement a TCP/IP stack on the NIC itself. NIC 900 may also be configured to facilitate TCP operations in a manner that is offloaded from the Operating System TCP facilities, whereby once a packet is sent outbound, NIC 900 is responsible for processing an ACK message and resending the packet if an ACK message is not received within an applicable TCP timeout value.

Generally, a NIC may be configured to store routing data for facilitating packet identification and flow classification, including forwarding filters and rules either locally or using a MMIO address space in system or host memory. When stored locally, this routing data may be stored in either DRAM 906 or SRAM 908. Routing data stored in a MMIO address space, such as NIC flow table data may be accessed by NIC 900 via Read DMA operations. Generally, setting up MMIO address space mapping may be facilitated by a NIC device driver in coordination with the operating system. The NIC device driver may also be configured to enable instructions in instruction store 910 to be updated via the operating system. Optionally, the instructions in instruction store may comprise firmware instructions that are stored in non-volatile memory, such as Flash memory, which may either be integrated on processor/controller 904 or mounted to NIC system board 902 (not shown).

The techniques and principles disclosed above enhance PCIe bandwidth utilization for LAN and WLAN Tx traffic. For many packets with a size of the TLP size minus the Tx descriptor size, bandwidth utilization is doubled. This is also advantageous for some packets with sizes greater than a TLP, as the number of TLPs used to transfer the packet data from host memory to a Tx buffer on the NIC or network adaptor may be reduced by 1 TLP. At the same time, embodiments may support current Tx descriptor utilization, enabling the same NIC, NIC chip, network adapter, etc. to be used in platforms that support both the novel Tx descriptor scheme disclosed herein and current Tx descriptor utilization.

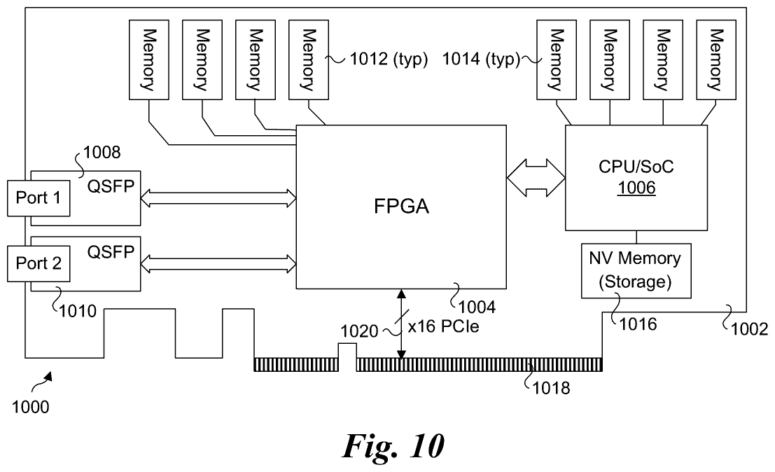

In addition to NIC chips and NIC cards, embodiments may be implemented on an infrastructure processing unit (IPU) and a SmartNIC chip and/or SmartNIC card. FIG. 10 shows one embodiment of IPU 1000 comprising a PCIe card including a circuit board 1002 having a PCIe edge connector to which various integrated circuit (IC) chips and modules are mounted. The IC chips and modules include an FPGA 1004, a CPU/SOC 1006, a pair of QSFP (Quad Small Form factor Pluggable) modules 1008 and 1010, memory (e.g., DDR4 or DDR5 DRAM) chips 1012 and 1014, and non-volatile memory 1016 used for local persistent storage. FPGA 1004 includes a PCIe interface (not shown) connected to a PCIe edge connector 1018 via a PCIe interconnect 1020 which in this example is 16 lanes. The various functions and logic in the embodiments described and illustrated herein may be implemented by programmed logic in FPGA 1004 and/or execution of software on CPU/SOC 1006. FPGA 1004 may include logic that is pre-programmed (e.g., by a manufacturing) and/or logic that is programmed in the field (e.g., using FPGA bitstreams and the like). For example, logic in FPGA 1004 may be programmed by a host CPU for a platform in which IPU 1000 is installed. IPU 1000 may also include other interfaces (not shown) that may be used to program logic in FPGA 1004. In place of QSFP modules 1008, wired network modules may be provided, such as wired Ethernet modules (not shown).

CPU/SOC 1006 employs a System on a Chip including multiple processor cores. Various CPU/processor architectures may be used, including but not limited to x86, ARM®, and RISC architectures. In one non-limiting example, CPU/SOC 1006 comprises an Intel® Xeon®-D processor. Software executed on the processor cores may be loaded into memory 1014, either from a storage device (not shown), for a host, or received over a network coupled to QSFP module 1008 or QSFP module 1010.

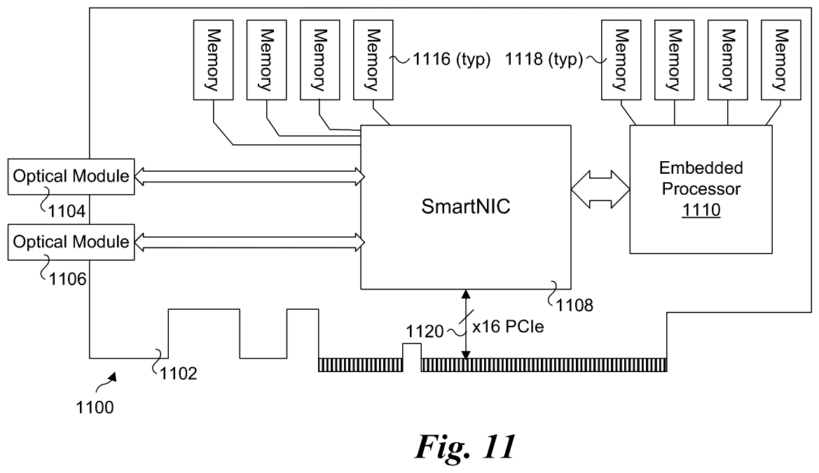

FIG. 11 shows a SmartNIC 1100 comprising a PCIe card including a circuit board 1102 having a PCIe edge connector and to which various integrated circuit (IC) chips and components are mounted, including optical modules 1104 and 1106. The IC chips include an SmartNIC chip 1108, an embedded processor 1110 and memory chips 1116 and 1118. SmartNIC chip 1108 is a multi-port Ethernet NIC that is configured to perform various Ethernet NIC functions, as is known in the art. In some embodiments, SmartNIC chip 1108 is an FPGA and/or includes FPGA circuitry.

Generally, SmartNIC chip 1108 may include embedded logic for performing various packet processing operations, such as but not limited to packet classification, flow control, RDMA (Remote Direct Memory Access) operations, an Access Gateway Function (AGF), Virtual Network Functions (VNFs), a User Plane Function (UPF), and other functions. In addition—various functionality may be implemented by programming SmartNIC chip 1108, via pre-programmed logic in SmartNIC chip 1108, via execution of firmware/software on embedded processor 1110, or a combination of the foregoing. The various functions and logic in the embodiments described and illustrated herein may be implemented by programmed logic in SmartNIC chip 1108 or and/or execution of software on embedded processor 1110.

Generally, an IPU and a DPU are similar, whereas the term IPU is used by some vendors and DPU is used by others. As with IPU/DPU cards, the various functions and logic in the embodiments described and illustrated herein may be implemented by programmed logic in an FPGA on the SmartNIC and/or execution of software on CPU or processor on the SmartNIC. In addition to the blocks shown, an IPU or SmartNIC may have additional circuitry, such as one or more embedded ASICs that are preprogrammed to perform one or more functions related to packet processing and Tx descriptor processing operations.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

While implementations employing Tx descriptors are described and illustrated above, the principles and teachings of this disclosure may apply to other types of work descriptors and associated work data. For example, a work descriptor may include all or a portion of the work data (data for which work is to be done on and/or with) in a first TLP, in a similar manner to the Tx descriptor containing all or a portion of the packet data. Non-limiting examples of such work descriptors may be used for work such as by not limited to compression and/or decompression, encryption and/or decryption, cryptographic operations, other accelerator operations and storage operations. If needed, the remaining portion of the work data will be transferred from the host to an accelerator device/apparatus/card or storage device/apparatus/card that is connected to the host via an I/O interconnect that uses TLPs.

The use of PCIe is likewise exemplary and non-limiting, as similar teachings and principles may be applied to other I/O interconnects and associated protocols that use TLPs or the like. Such I/O interconnects may include future generations and/or extensions of PCIe interconnect technologies that use TLPs or the like under which the PCIe moniker is replaced with a new moniker.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Italicized letters, such as ‘n’, ‘M’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (e.g., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method performed by a computing device having host memory and a host processor coupled to a network interface controller (NIC) via a peripheral component interconnect express (PCIe) interconnect, comprising:
generating a packet comprising packet data to be sent outbound to a network via the NIC;
generating a transmit (Tx) descriptor associated with the packet comprising descriptor data and at least a portion of the packet data, the descriptor data configured to be processed by the NIC; and
transferring the Tx descriptor in a single transaction level packet (TLP) over the PCIe interconnect to the NIC.

2. The method of claim 1, further comprising:
configuring or retrieving a transaction level packet (TLP) size used for the PCIe interconnect;
when a size of a packet to be sent outbound to a network via the NIC plus a size of descriptor data for the packet is less than or equal to the TLP size,
buffering the packet with the descriptor data in a Tx descriptor in host memory; and
transferring the Tx descriptor to the NIC over the PCIe interconnect using a single TLP.

3. The method of claim 1, further comprising:
configuring or retrieving a transaction level packet (TLP) size used for the PCIe interconnect;
when a size of a packet to be sent outbound to a network via the NIC plus a size of descriptor data for the packet is greater than a TLP size,
buffering a first portion of packet data for the packet with the descriptor data as a Tx descriptor in host memory;
transferring a first TLP comprising the Tx descriptor over the PCIe interconnect to the NIC; and
transferring a remaining portion of packet data for the packet to the NIC over the PCIe interconnect using at least one additional TLP.

4. The method of claim 3, wherein the NIC comprises memory, further comprising:
using a first Direct Memory Access (DMA) transaction to transfer the Tx descriptor to a first buffer in memory on the NIC; and
using one or more DMA read transactions originating from the NIC to transfer the remaining portion of the packet data to a second buffer in memory on the NIC.

5. The method of claim 4, further comprising:
copying the first portion of the packet data from the Tx descriptor in the first buffer in memory on the NIC to the second buffer,
wherein the first portion of the packet data from the Tx descriptor is copied to the second buffer before or after the remaining portion is transferred to the second buffer, and wherein the packet is recreated when the first portion of the packet data and the remaining portion of the packet data are buffered in the second buffer.

6. The method of claim 1, wherein the descriptor data includes a host memory address identifying a location in host memory where the packet is stored or buffered.

7. The method of claim 1, wherein the descriptor data includes at least one flag indicating at least one of:
the Tx descriptor contains packet data for the packet; and
the packet data has a size greater than a TLP.

8. The method of claim 1, wherein the descriptor data includes an address in host memory offset one TLP size minus a size of the descriptor data from an address at which the packet is stored or buffered in host memory.

9. A non-transitory machine-readable medium having instructions stored thereon configured to be executed on a processor of a computing device having host memory, the processor having an input/output (I/O) interface coupled to a network interface controller (NIC) via a I/O interconnect, wherein execution of the instructions enables to computing device to:
generate or access a packet comprising packet data to be sent outbound to a network via the NIC; and
generate a transmit (Tx) descriptor associated with the packet comprising descriptor data and at least a portion of the packet data, the descriptor data configured to be processed by the NIC.

10. The non-transitory machine-readable medium of claim 9, wherein execution of the instructions enables the computing device to:
at least one of configuring and detecting a transaction level packet (TLP) size used for the I/O interconnect;
when a size of a packet to be sent outbound to a network via the NIC plus a size of descriptor data for the packet is less than or equal to the TLP size,
buffering the packet with the descriptor data as a Tx descriptor in host memory; and
transferring a TLP comprising the Tx descriptor to the NIC over the I/O interconnect.

11. The non-transitory machine-readable medium of claim 9, wherein execution of the instructions enables the computing device to:
at least one of configuring and detecting a transaction level packet (TLP) size used for the I/O interconnect;
when a size of a packet to be sent outbound to a network via the NIC plus a size of descriptor data for the packet is greater than a TLP size,
buffering a first portion of the packet data with the descriptor data as a Tx descriptor in host memory;
transferring a first TLP comprising the Tx descriptor over the I/O interconnect to the NIC; and
transferring a remaining portion of the packet data to the NIC over the I/O interconnect using at least one additional TLP.

12. The non-transitory machine-readable medium of claim 11, wherein the NIC comprises memory, and wherein execution of the instructions enables the computing device to use a Direct Memory Access (DMA) operation originating from the host to transfer data contained in the first TLP to a first buffer in memory on the NIC.

13. The non-transitory machine-readable medium of claim 12, wherein the NIC includes a network port having an egress queue or buffer, and wherein execution of the instructions enables the computing device to:
copy the first portion of the packet data from the first buffer in memory on the NIC to a slot in the egress queue or buffer;
append the remaining portion of the packet data in the second buffer to the first portion of the packet data to recreate the packet; and
transmit the packet onto the network via the network port.

14. The non-transitory machine-readable medium of claim 9, wherein the descriptor data includes an address in host memory at which the packet is stored in host memory.

15. The non-transitory machine-readable medium of claim 9, wherein the descriptor data includes an address in host memory offset one TLP size minus a size of the descriptor data from an address at which the packet is stored or buffered in host memory.

16. A network apparatus, having at least one of onboard memory and an interface to access external memory, one or more network ports or one or more interfaces configured to be coupled to one or more network ports, and first a Peripheral Component Interconnect Express (PCIe) interface configured to be connected to a second PCIe interface of a processor via a PCIe interconnect, the network apparatus configured to:
read a first transmit (Tx) descriptor associated with a first packet comprising packet data to be transmitted to a network via a network port, the Tx descriptor including descriptor data and packet data comprising at least a portion of the packet data for the first packet;
extract the packet data from the Tx descriptor; and
buffer the packet data in a buffer in the onboard memory or the external memory.

17. The network apparatus of claim 16, wherein the network apparatus is connected to a processor of a host computing device having host memory via the PCIe interconnect, further configured to:
determine the packet data in the first Tx descriptor comprises a first portion of the packet data for the first packet;
originate at least one read direct memory access (DMA) read transaction to read a remaining second portion of the packet data for the first packet from a buffer in the host memory in which the first packet is buffered; and
append the second portion of the packet data to the first portion of the packet data in the buffer in onboard memory or external memory.

18. The network apparatus of claim 17, further configured to:
determine, using descriptor data in the first Tx descriptor, a memory address in host memory at which a start of the second portion of the packet data is located; and
determine using descriptor data in the first Tx descriptor, a size of the second portion of the packet data.

19. The network apparatus of claim 16, wherein the network apparatus is connected to a processor of a host computing device including host memory via the PCIe interconnect, the host computing device implementing a Tx descriptor ring having a plurality of slots in which Tx descriptors are buffered, including the first Tx descriptor, further configured to:
initiate a first DMA read transaction to retrieve a copy of the first Tx descriptor from the Tx descriptor ring; and
buffer the copy of the first Tx descriptor in the onboard memory or the external memory.

20. The network apparatus of claim 19, further configured to:
initiate a second DMA read transaction to retrieve a copy of a second Tx descriptor from the Tx descriptor ring;
process the second Tx descriptor to determine it contains descriptor data and does not contain packet data for a second packet;
determine, using the second Tx descriptor, a memory address in the host memory at which the second packet is buffered;
initiate a third DMA read transaction to retrieve a copy of the second packet from the host memory; and
buffer the copy of the second packet in a memory buffer in the onboard memory or the external memory.
